(19) United States
(12) Patent Application Publication
(10) Pub. No.: US 2015/0077972 A1
(43) Pub. Date: Mar. 19, 2015

(54) LIGHT EMITTING DEVICE

(71) Applicant: Nichia Corporation, Anan-shi (JP)

(72) Inventors: Takafumi Sugiyama, Yoshinogawa-shi (JP); Eiichiro Okahisa, Tokushima-shi (JP); Kazutaka Tsukayama, Tokushima-shi (JP); Chiaki Masutomi, Anan-shi (JP)

(21) Appl. No.: 14/488,162

(22) Filed: Sep. 16, 2014

(30) Foreign Application Priority Data
Sep. 17, 2013 (JP) 2013-192030

(51) Int. Cl. F21V 9/08; F21V 13/08; F21V 8/00; F21V 9/16

(52) U.S. Cl. CPC F21V 9/08; F21V 9/16; F21V 13/08; G02B 6/0005; F21Y 2101/025
USPC 362/84; 362/553

(57) ABSTRACT

A light emitting device includes a semiconductor laser element configured to emit laser light having a peak wavelength of 460 nm or less; a base body having a through-hole through which the laser light passes from a bottom to a top of the base body; a fluorescent member disposed so as to close the through-hole; and a filter configured to reflect fluorescence from the fluorescent member, the filter being disposed below the fluorescent member at a position above and spaced apart from a plane including a lower end of the through-hole. At least in a portion lower than the filter, an inner surface of the base body defining the through-hole includes an inclination surface that is inclined such that the through-hole expands from a lower part of the through-hole toward an upper part of the through-hole. A reflection layer containing aluminum is formed on the inclination surface.

### CROSS-REFERENCE TO RELATED APPLICATION

This application claims priority to Japanese Patent Application No. 2013-192030, filed on Sep. 17, 2013, which is hereby incorporated by reference in its entirety.

### BACKGROUND

1. Technical Field

The present disclosure relates to a light emitting device including a semiconductor laser element and a fluorescent member.

2. Description of Related Art

A light emitting device described in JP 2009-272576 A has a semiconductor light emitting device and a wavelength conversion member. In the device, a reflection member made of a material containing silver is disposed on an inner wall surface of a through-hole (e.g., refer to FIG. 4 and FIG. 5). Accordingly, it is expected to improve light extraction efficiency.

However, in a lighting device described in JP 2009-272576 A, there is a possibility that silver serving as a reflection member is sulfurized with time, resulting in a decrease in the optical output.

### SUMMARY

Certain embodiments of the present invention have been made in view of the above-mentioned problem, and it is an object of certain embodiments of the present invention to provide a light emitting device having high light output without using silver for a reflection layer.

A light emitting device according to the present invention includes a semiconductor laser element for emitting laser light having a peak wavelength of 460 nm or less, a base body provided with a through-hole through which the laser light passes from a bottom to a top of the base body, and a fluorescent member disposed so as to close the through-hole. Further, a filter for reflecting fluorescence from the fluorescent member is disposed below the fluorescent member, at a position above and spaced apart from a plane including a lower end of the through-hole. Moreover, at least in a portion lower than the filter, an inner surface of the base body defining the through-hole includes an inclination surface inclined such that the through-hole expands from a lower part toward an upper part. A reflection layer which contains aluminum is formed on the inclination surface.

In accordance with certain embodiments, a light emitting device with high light output can be obtained even though silver is not used for the reflection layer.

### BRIEF DESCRIPTION OF THE DRAWINGS

FIG. 1 is a schematic sectional view for illustrating a light emitting device according to a first embodiment.

FIG. 2 is a graph showing measurement results of reflectances of silver and aluminum.

FIG. 3 is a schematic sectional view for illustrating a light emitting device according to a second embodiment.

FIG. 4 is a schematic sectional view for illustrating a light emitting device according to a third embodiment.

FIG. 5 is a schematic sectional view for illustrating a light emitting device according to a fourth embodiment.

FIG. 6 is a view for illustrating a light emitting device according to a fifth embodiment.

FIG. 7 is a schematic sectional view showing a tip portion of the light emitting device according to the fifth embodiment.

### DETAILED DESCRIPTION OF THE EMBODIMENTS

Hereinafter, embodiments of the present invention will be described with reference to the drawings. The embodiments shown below are intended as illustrative to give a concrete form to technical ideas of the present invention, and the scope of the invention is not limited to those described below. The sizes and the positional relationships of the members in each of the drawings are occasionally shown exaggerated for ease of explanation. Further, in the description below, the same designations or the same reference numerals denote the same or like members and duplicative description will be appropriately omitted.

### First Embodiment

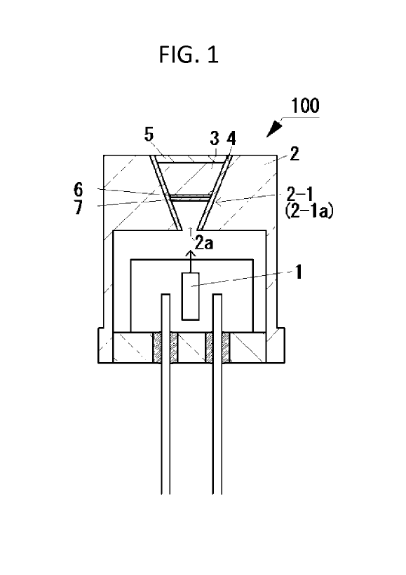

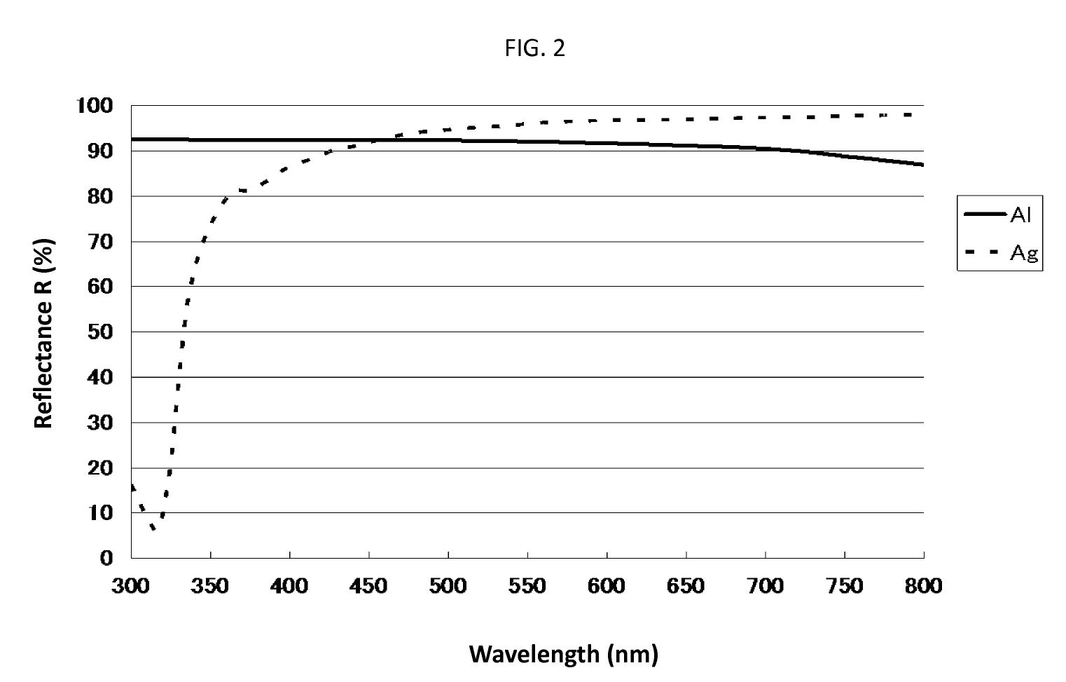

FIG. 1 shows a schematic sectional view of a light emitting device 100 according to a first embodiment. FIG. 2 is reflectance spectra of silver and aluminum in the wavelength range of 300 nm to 800 nm. The respective reflectance values were calculated from the measured indices of refraction.

The light emitting device 100 includes a semiconductor laser element 1 for emitting laser light having a peak wavelength of 460 nm or less, a base body 2 provided with a through-hole 2a through which the laser light passes from a bottom to a top of the base body 2 and a fluorescent member 3 disposed so as to be close the through-hole 2a. Further, a filter 7 for reflecting fluorescence from the fluorescent member 3 is disposed below the fluorescent member 3 at a position above and spaced apart from a plane including a lower end of the through-hole 2a. Moreover, at least in a portion lower than the filter 7, an inner surface 2-1 of the base body defining the through-hole 2a includes an inclination surface 2-1a which is inclined such that the through-hole 2a expands from a lower part toward an upper part. A reflection layer 4 which contains aluminum is formed on the inclination surface 2-1a.

Accordingly, a light emitting device of a high light output can be obtained without the use of silver. Hereinafter, the reason will be described.

In the case where the filter 7 for reflecting fluorescence from the fluorescent member 3 is disposed below the fluorescent member 3, fluorescence traveling downwardly from the inside of the fluorescent member 3 can be reflected upwardly, but part of laser light, with which the fluorescent member 3 is irradiated, is reflected on the surface of a phosphor contained in the fluorescent member 3, passes through the filter 7 and travels downwardly. Part of the laser light traveling downward becomes return light and is not extracted to outside, resulting in a decrease in the light extraction efficiency. In order to solve this problem, a reflection layer made of silver which has a high reflectance may be disposed on an inner surface of the base body so that the laser light which travels downward can be reflected upward. However, as shown in FIG. 2, when a reflection layer made of silver and a reflection layer made of aluminum are formed and the reflectances thereof are compared with each other, it was found that the reflectance of aluminum is higher than a reflectance of silver in a wavelength region of about 460 nm or less.

Accordingly, in the present embodiment, a semiconductor laser element 1 for emitting laser light having a peak wavelength of 460 nm or less is used, a specific filter 7 for reflecting fluorescence is disposed below the fluorescent member 3, and further a reflection layer 4 which contains aluminum is formed below the filter 7. With this configuration, the laser light which has a peak wavelength of 460 nm or less and travels downward can be reflected upward by the reflection layer 4 which contains aluminum, and therefore a light emitting device with high light output can be obtained. Moreover, with the use of aluminum instead of silver as the reflection layer, a reduction in light output due to sulfurization of the reflection layer can be prevented. Hereinafter, main members used in the light emitting device 100 will be described in detail. In addition to one of each, a plurality of members may be employed.

### (Semiconductor Laser Element 1)

In the light emitting device 100, a semiconductor laser element 1 having a peak wavelength of 445 nm is used as an excitation light source of the fluorescent member 3.

As shown in FIG. 2, aluminum has a reflectance higher than a reflectance of silver at a wavelength of 460 nm or less, and therefore laser light having a peak wavelength of 460 nm or less is reflected efficiently by the reflection layer 4 containing aluminum. In addition, referring to FIG. 2, it is conceivable that aluminum has a reflectance higher than a reflectance of silver even at a wavelength less than 300 nm, but the semiconductor laser element 1 with a peak wavelength of 300 nm or more and 460 nm or less is preferable, 400 nm or more and 455 nm or less is more preferable, and a peak wavelength of 440 nm or more and 450 nm or less is further preferable. When the peak wavelength of laser light is set to a given length or more, the laser light can be visible light, and a desired color (for example, white) can be obtained by mixing the laser light with fluorescence. Further, when the peak wavelength of laser light is set to a given length or less, it is possible to maintain a high reflectance as compared with a case where the reflection layer 4 contains silver.

(Base body 2)

The base body 2 is a member for supporting the fluorescent member 3. The base body 2 has a through-hole 2a which expands from a lower part toward an upper part, and the through-hole 2a is defined by the base body inner surface 2-1. Further, the base body inner surface 2-1 includes the inclination surface 2-1a inclined such that the through-hole 2a expands from a lower part toward an upper part throughout the whole region of the base body inner surface 2-1. The through-hole 2a is formed so as to expand toward an upper part, and therefore part of laser light traveling downwardly from the fluorescent member 3 can be extracted upwardly by reflection.

As a material for the base body 2, copper, iron, an iron alloy or the like can be used, and in the present embodiment, a material predominantly composed of copper is used from the viewpoint of a heat dissipating property.

In FIG. 1, the inner surface of the base body 2 is inclined in the entire area of the base body inner surface 2-1 such that a diameter of the through-hole 2a increases gradually; however, only a portion of the inner surface may be inclined.

(Fluorescent member 3)

The fluorescent member 3 contains at least a phosphor, and is a member for converting a wavelength of light from the semiconductor laser element 1 to a longer wavelength. A phosphor itself may be used as the fluorescent member 3; however, typically, the fluorescent member 3 contains a phosphor (to be precise, a plurality of phosphor particles) and a binder for binding the phosphor particles. In the light emitting device 100, a YAG-based phosphor and the binder made of aluminum oxide are used for the fluorescent member 3.

The fluorescent member 3 is disposed so as to close the through-hole 2a. That is, the fluorescent member 3 can be arranged so as to close the through-hole 2a at a portion outside the through-hole 2a (for example, at an upper surface of the base body 2), or can be arranged such that a portion of the fluorescent member 3 enters into the through-hole 2a. The fluorescent member 3 is preferably arranged only within the through-hole 2a as with the present embodiment. When the fluorescent member 3 is arranged only within the through-hole 2a, light traveling from the inside of the fluorescent member 3 to a lateral direction can also be reflected on the inner surface 2-1 of the base body, and therefore it becomes easy to control directionality of light.

A material of the phosphor can be selected from known materials, and a material which is combined with the semiconductor laser element 1 to form white light is preferably selected. For example, in the case where a semiconductor laser element 1 to emit blue light is used as the semiconductor laser element 1, a phosphor emitting yellow light upon receiving an excitation light from the semiconductor laser element 1 can be used. Examples of the phosphor emitting yellow light include YAG-based phosphors, TAG-based phosphors, and strontium-silicate-based phosphors. Further, in the case where a semiconductor element to emit light of a short wavelength (e.g., ultraviolet light) rather than blue light is used as the semiconductor laser element 1, phosphors each emitting blue, green or red light can be used. Light of the respective colors may be obtained by using one type of phosphor or light of the respective colors may be obtained by using several types of phosphors.

As the binder, an organic material composed of a silicone resin or an epoxy resin, or an inorganic material such as silicon oxide (SiO₂), aluminum oxide (Al₂O₃), titanium oxide (TiO₂) or glass can be used. Among those, an inorganic material can be preferably used. With the use of an inorganic material as the binder, it is possible to suppress discoloration or deformation of the binder due to heat or light. In the case where the inorganic material is used as the binder, aluminum oxide is particularly preferably used. The reason for this is that aluminum oxide has a high melting point and high resistance to heat or light.

In the case where the organic material is used as the binder, for example, it is possible that phosphor particles are mixed with a thermosetting resin such as a silicone resin, and the resulting mixture is formed into a desired shape, and then cured by heating. On the other hand, in the case where the inorganic material is used as the binder, for example, it is possible that phosphor particles are mixed with inorganic material particles serving as a binder, and the resulting mixture is solidified in a desired shape by using a sintering method.

### (Reflection Layer 4)

The reflection layer 4 is a member for reflecting light traveling from the fluorescent member 3 to the inner surface 2-1 of the base body to extract the light. The reflection layer 4 is composed of a material containing aluminum. Herein, the term “material containing aluminum” means a material which contains aluminum in a purity of 80% or more, preferably in a purity of 90% or more, more preferably in a purity of 95% or more, and even more preferably in a purity of 99% or more. In the present embodiment, aluminum having a purity of 99.9% is used as the reflection layer 4. The reflection layer 4 can have a constitution of substantially containing no silver. That is, the reflection layer 4 may have a constitution of containing no silver at all, or may have a constitution of containing a trace amount of silver to such an extent that the reflection layer 4 is not sulfurized.

As shown in FIG. 2, aluminum has a reflectance higher than a reflectance of silver for light having a wavelength of 460 nm or less and is a material more difficult to be sulfurized than silver. By using a material containing aluminum as the reflection layer 4, part of laser light traveling downward can be reflected, and therefore a light output can be increased as the entire light emitting device. Further, aluminum is hardly sulfurized as compared with silver, and therefore a reduction in light output due to sulfurization can be suppressed.

The reflection layer 4 can have a layer thickness of preferably 100 nm or more and 6000 nm or less, and more preferably 500 nm or more and 4000 nm or less. With a thickness of the reflection layer 4 equal to or greater than a given thickness, an adequate reflectance can be secured, and with a thickness equal to or less than a given thickness, generation of cracks in the reflection layer 4 can be prevented.

In the light emitting device 100, the reflection layer 4 is disposed on the entire area of the inner surface 2-1 of the base body. However, the reflection layer 4 may be disposed on the inclination surface 2-1a of the inner surface 2-1 of the base body at least to a portion lower than the filter 7. Accordingly, part of laser light traveling downward from the fluorescent member 3 through the filter 7 can be extracted by reflection.

### (Light Transmissive Member 5)

In the case where the fluorescent member 3 is formed within the through-hole 2a, a light transmissive member 5 may be disposed on the upper surface of the fluorescent member 3. The light transmissive member 5 is a member for fixing the fluorescent member 3 to the base body 2, and in the present embodiment, borosilicate glass is used as the light transmissive member 5.

Unlike the present embodiment, the fluorescent member 3 can also be fixed within the through-hole 2a by fusion bonding a binder constituting the fluorescent member 3 to the inner surface 2-1 of the base body. However, in this case, a material constituting the binder is limited to a material having a rather low melting point. In the case where the binder has a low melting point, the binder may be discolored or deformed due to heat generated from the phosphor (phosphor particles) upon using a high-power semiconductor laser. Thus, in the light emitting device 100 of the present embodiment, the light transmissive member 5 is arranged above the fluorescent member 3 and is fusion bonded to the upper surface of the fluorescent member 3 and the inner surface 2-1 of the base body. Thus, the fluorescent member 3 is fixed within the through-hole 2a. This makes it possible to easily fix the fluorescent member 3 to the base body 2 even with the use of a binder having a high melting point, which is difficult to fusion bond, for the fluorescent member 3. For the light transmissive member 5, a material having a melting point lower than a melting point of the binder constituting the fluorescent member 3 can be used, and soda glass, borosilicate glass, lead glass or the like can be used.

The light transmissive member 5 may contain a light-scattering material, and for example, silicon oxide, aluminum oxide, titanium oxide or the like can be used as the light-scattering material. Accordingly, light can be scattered for extraction, and therefore desired light distribution is easily achieved.

### (Filter 7)

The filter 7 for reflecting fluorescence from the fluorescent member 3 is disposed below the fluorescent member 3 and is spaced apart from and above a plane which includes a lower end of the through-hole 2a. That is, the filter 7 is arranged such that the inclination surface 2-1a having the reflection layer 4 formed thereon exists in a portion lower than the filter 7. By employing such a configuration, the inclination surface 2-1a having the reflection layer 4 formed thereon is present in a portion lower than the filter 7, and therefore light can be efficiently extracted. In addition, the filter 7 is arranged with an incident angle of 90°±30° with respect to the traveling direction of laser light. With this configuration, the laser light can be easily incident thereon.

The filter 7 is a so-called DBR (Distributed Bragg Reflector). For example, a dielectric multilayer film formed by alternately laminating a material with a high refractive index and a material with a low refractive index can be used for the filter 7. Examples of the materials thereof include SiO₂, Al₂O₃, MgF₂, AlN, Nb₂O₅, ZrO₂ and the like. Particularly, from the perspective of light resistance and refractive index, AlN, SiO₂, Nb₂O₅, TiO₂, and Al₂O₃ can be preferably used. This makes it possible to reflect light incident in a direction mainly perpendicular to the filter 7. In the light emitting device 100, a laminate of a SiO₂ layer and an Nb₂O₅ layer is taken as a pair, and an article formed by repeating this lamination a plurality of times is used as the filter 7.

In the case where a semiconductor element to emit light having a wavelength in the blue region is used as the semiconductor laser element 1, the filter 7 is configured to reflect yellow light (light having a wavelength of 550 nm to 600 nm). Further, in the case where a semiconductor element to emit UV light (light having a wavelength of 350 nm to 420 nm) is used as the semiconductor laser element 1, the filter 7 is configured to reflect blue light, green light and/or red light. The filter 7 can be appropriately configured according to the refractive indices, the thicknesses, and the number of pairs of members constituting the respective layers, for light having a wavelength desired to be reflected.

### (Low Refractive Index Layer 6)

In the light emitting device 100, a low refractive index layer 6, which has a refractive index smaller than a refractive index of the fluorescent member 3, is disposed between the fluorescent member 3 and the filter 7 at a portion lower than the fluorescent member 3. In the case where the fluorescent member 3 is configured to include a phosphor and a binder, a material having a refractive index smaller than the refractive indices of the phosphor and the binder is used. Accordingly, of the return light from the fluorescent member 3 to the semiconductor laser element 1, light incident at shallow angles can be extracted by total reflection. As a material of the low refractive index layer 6, for example, silicon oxide, aluminum oxide and the like can be used. The low refractive index layer 6 may have a thickness of 150 nm or more and 2000 nm or less, and preferably 300 nm or more and 1000 nm or less.

Further, after the fluorescent member 3 and the filter 7 are joined to the base body 2, a protective layer may be disposed on the outermost surfaces of the respective members by using an atomic layer deposition method. According to the atomic layer deposition method, a layer can be formed at a molecular level, and therefore it is possible to fill a partial gap generated between the fluorescent member 3 and the base body 2. Accordingly, heat generated in the fluorescent member 3 can be easily released to the base body 2.

### (Other Aspects)

A lens for controlling the orientation of mixed-color light of laser light and fluorescence emitted from the light emitting device 100 may be disposed outside of the light emitting device 100. In this case, for example, a filter for eliminating light of a specific wavelength region may be disposed on the surface of the lens. This makes it possible to eliminate a part of light having unnecessary wavelength when a desired chromaticity cannot be obtained from a light emitting device, thereby allowing a desired chromaticity to be obtained. That is, even a non-standard light emitting device becomes usable, and therefore, yields can be improved.

### Second Embodiment

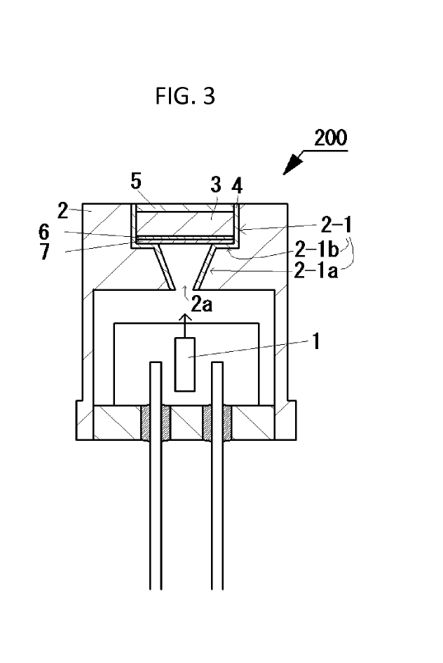

FIG. 3 shows a schematic sectional view of a light emitting device 200 according to a second embodiment. The light emitting device 200 has a substantially similar configuration to that described in the first embodiment except for that described below.

In the light emitting device 200, as shown in the sectional view of FIG. 3, a flat plane 2-1b orthogonal to a traveling direction of laser light is provided at a portion of the inner surface 2-1 of the base body, and only an inner surface lower than the flat plane 2-1b is formed into an inclination surface 2-1a. In FIG. 3, the reflection layer 4 is disposed in the entire area of the inner surface of the base body 2-1. However, the reflection layer 4 may be disposed only on the inclination surface 2-1a at least in a portion lower than the filter 7.

According to the present embodiment, a side surface of the fluorescent member 3 is not needed to be inclined, and therefore preparation of the fluorescent member 3 is easy, and this structure facilitates placing of the fluorescent member 3. Moreover, not only the side surface of the fluorescent member 3, but also a lower surface of the fluorescent member 3 can be thermally connected to the base body 2, and therefore it is easy to improve a heat dissipating property.

### Third Embodiment

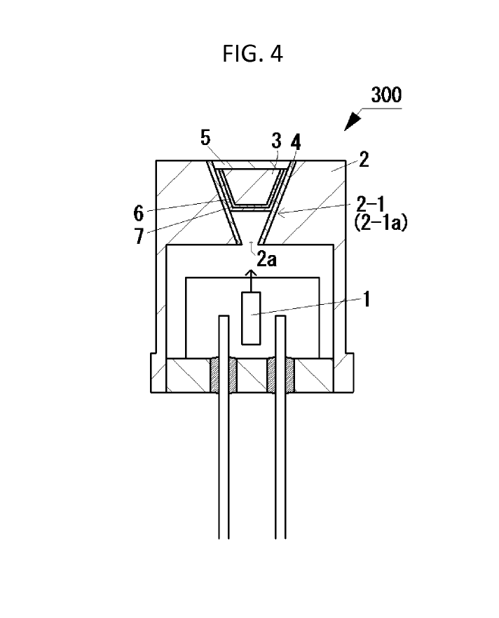

FIG. 4 shows a schematic sectional view of a light emitting device 300 according to a third embodiment. The light emitting device 300 has a substantially similar configuration to that described in the first embodiment except for that described below.

In the light emitting device 300, the fluorescent member 3 is formed within the through-hole 2a, and the filter 7 is disposed between the inner surface 2-1 of the base body and the fluorescent member 3 at a portion lateral to the fluorescent member 3. Moreover, the reflection layer 4 is disposed between the inner surface 2-1 of the base body and the filter 7 at the portion lateral to the fluorescent member 3. Further, the low refractive index layer 6 is disposed between the fluorescent member 3 and the filter 7.

By disposing the low refractive index layer 6, the filter 7 and the reflection layer 4 up to the portion lateral to the fluorescent member 3, light traveling from the inside of the fluorescent member 3 in a lateral direction can be extracted by reflection, and the light output of the entire light emitting device can be improved.

### Fourth Embodiment

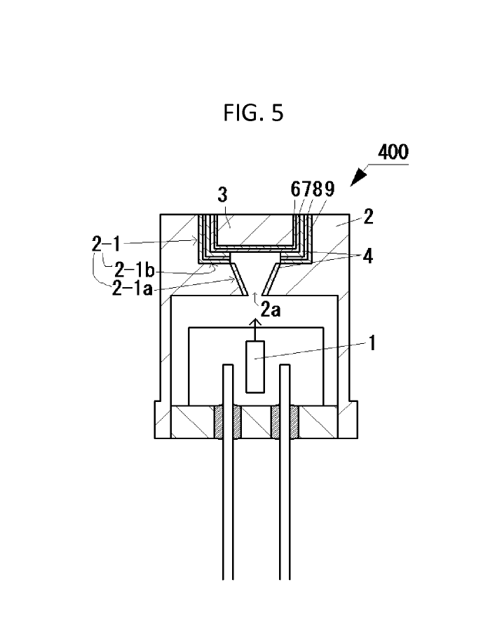

FIG. 5 shows a schematic sectional view of a light emitting device 400 according to a fourth embodiment. The light emitting device 400 has a substantially similar configuration to that described in the second embodiment except for that described below.

In the light emitting device 400, the fluorescent member 3 is formed within the through-hole 2a, and the filter 7 is disposed between the inner surface 2-1 of the base body and the fluorescent member 3 at a portion lateral to the fluorescent member 3. Moreover, the reflection layer 4 is disposed between the inner surface 2-1 of the base body and the filter 7 at the portion lateral to the fluorescent member 3. Further, the low refractive index layer 6 is disposed between the fluorescent member 3 and the filter 7. In this case, the base body 2 can be connected with the fluorescent member 3 by using the light transmissive member 5 as in the second embodiment. However, in the light emitting device 400, the base body 2 is connected with the fluorescent member 3 by using the connection member 9.

Accordingly, light traveling from the inside of the fluorescent member 3 to a lateral direction can be extracted by reflection, and therefore the light output of the light emitting device can be improved. The fluorescent member 3 is joined with the base body 2 in the portion lateral to the fluorescent member 3, and therefore, it is not necessary to form a member on a surface for light extraction (upper surface) of the fluorescent member 3. Accordingly, light absorbed by the light transmissive member 5 can be extracted as it is to outside, and therefore, the light output can be improved.

In the case where the fluorescent member 3 is joined with the base body 2 with the connection member 9, the reflection layer 4 to be formed on the base body 2 and the reflection layer 4 to be formed at the portion lateral to the fluorescent member 3 are respectively formed in separate operations. Then, the base body 2 and the fluorescent member 3, which are respectively provided with the reflection layer 4, are connected to each other with the connection member 9. For this reason, the reflection layers 4 are disposed partially separated from each other. The connection member 9 and a barrier layer 8 will be described below.

### (Connection Member 9)

The connection member 9 is disposed between the reflection layer 4 and the base body 2. As the connection member 9, a conductive paste of silver, gold, palladium or the like, a gold-tin eutectic solder, or the like may be employed. It is preferred to connect the reflection layer 4 with the base body 2 by use of a gold-tin eutectic solder with a high heat-dissipating property. This makes adhesion between the base body 2 and the fluorescent member 3 excellent, and therefore a heat dissipating property can be improved.

### (Barrier Layer 8)

The barrier layer 8 may also be disposed between the connection member 9 and the reflection layer 4. This makes it possible to prevent the connection member 9 from diffusing into the reflection layer 4, and therefore a material of the connection member 9 is selected in a wide range. Ti, Ni, Ru, Pt or the like can be used for the barrier layer 8.

### Fifth Embodiment

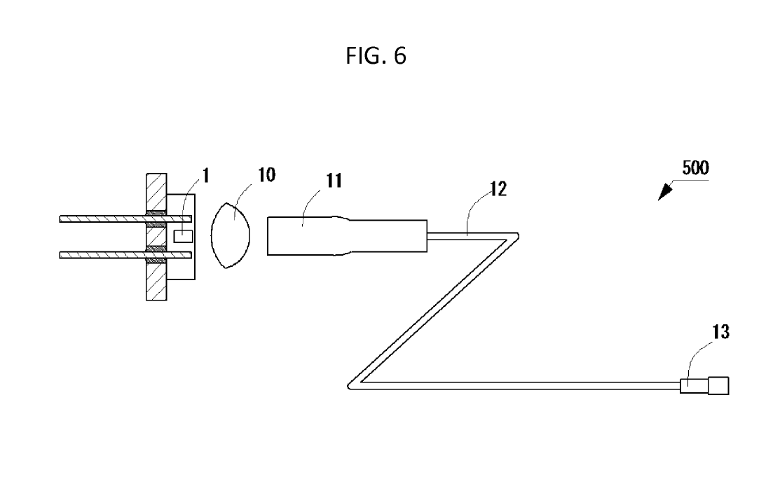

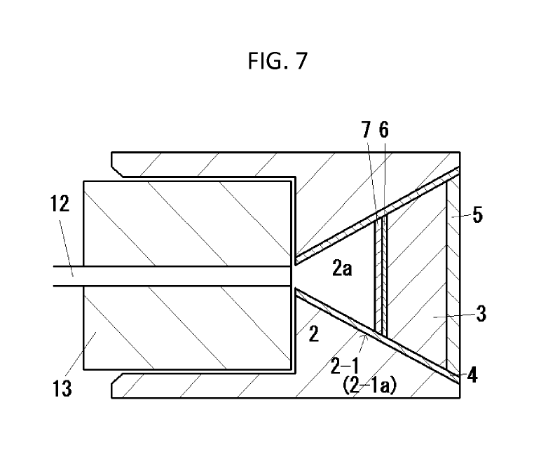

FIG. 6 shows a conceptual view of a light emitting device 500 according to a fifth embodiment. Further, FIG. 7 shows a sectional view for illustrating a structure of a tip portion (vicinity of the base body 2) of the light emitting device 500. The light emitting device 500 has a substantially similar configuration to that described in the first embodiment except for having the semiconductor laser element 1, a lens 10 for collecting light from the semiconductor laser element 1, a connector 11 for connection with an optical fiber 12, the optical fiber 12 and a tip member 13 for holding a tip of the optical fiber 12.

According to the present embodiment, the optical fiber 12 is disposed between the semiconductor laser element 1 and the fluorescent member 3, and therefore a positional relationship between the semiconductor laser element 1 and the fluorescent member 3 can be freely designed.

In the light emitting device 500, the inclination surface 2-1a is employed in the entire area of the inner surface 2-1 of the base body, but a flat plane may be provided for the inner surface 2-1 of the base body as with the light emitting device 200, or the filter 7 or the like may be formed up to the portion lateral to the fluorescent member 3 as in the light emitting device 300 and the light emitting device 400. The lens 10, the connector 11, the optical fiber 12 and the tip member 13 will be described below.

### (Lens 10)

The lens 10 is arranged between the semiconductor laser element 1 and the optical fiber 12. This arrangement makes it possible to collect the light from the semiconductor laser element 1 to efficiently output the light to the fluorescent member 3. The lens 10 is preferably made of inorganic glass, but, the lens 10 may be formed of resin or the like.

### (Connector 11)

The connector 11 is a component for holding the optical fiber 12. The connector 11 facilitates positioning of an end portion of the optical fiber 12.

### (Optical Fiber 12)

The optical fiber 12 is composed of, for example, glass, preferably quartz glass, resin or the like. The optical fiber 12 can be bent, and therefore a relative positional relationship between the semiconductor laser element 1 and the fluorescent member 3 can be comparatively freely designed.

### (Tip Member 13)

The tip member 13 is a member disposed at the laser light emitting end in the optical fiber 12, and is formed to surround the outer periphery of the optical fiber 12. With the tip member 13, processing of the tip portion of the optical fiber 12 can be facilitated. The tip member 13 may be composed of a material having a high reflectance to laser light or fluorescence. Examples of the material include aluminum, platinum, aluminum oxide, zirconia, diamond and the like. Aluminum is preferably used.

It is to be understood that although the present invention has been described with regard to preferred embodiments thereof, various other embodiments and variants may occur to those skilled in the art, which are within the scope and spirit of the invention, and such other embodiments and variants are intended to be covered by the following claims.

What is claimed is:

1. A light emitting device comprising:
a semiconductor laser element configured to emit laser light having a peak wavelength of 460 nm or less;
a base body having a through-hole through which the laser light passes from a bottom to a top of the base body;
a fluorescent member disposed so as to close the through-hole; and
a filter configured to reflect fluorescence from the fluorescent member, the filter being disposed below the fluorescent member at a position above and spaced apart from a plane including a lower end of the through-hole,
wherein, at least in a portion lower than the filter, an inner surface of the base body defining the through-hole includes an inclination surface that is inclined such that the through-hole expands from a lower part of the through-hole toward an upper part of the through-hole, and
wherein a reflection layer containing aluminum is formed on the inclination surface.

2. The light emitting device according to claim 1, wherein the fluorescent member is disposed within the through-hole.

3. The light emitting device according to claim 2, wherein the filter is further disposed between the inner surface of the base body and the fluorescent member at a portion lateral to the fluorescent member.

4. The light emitting device according to claim 3, wherein the reflection layer is further disposed between the inner surface of the base body and the filter at a portion lateral to the fluorescent member.

5. The light emitting device according to claim 1, wherein a low refractive index layer is disposed between the filter and the fluorescent member in a portion lower than the fluorescent member, the low refractive index layer having a refractive index smaller than a refractive index of the fluorescent member.

6. The light emitting device according to claim 1, wherein the filter is a Distributed Bragg Reflector comprising a dielectric multilayer film.

7. The light emitting device according to claim 3 further comprising, at a side of the fluorescent member, a low refractive index layer having a refractive index smaller than a refractive index of the fluorescent member, the low refractive index layer being disposed between the fluorescent member and the filter.

8. The light emitting device according to claim 1, wherein the reflection layer has a layer thickness of 100 nm or more and 6000 nm or less.

9. The light emitting device according to claim 1, wherein a light transmissive member is disposed on a upper surface of the fluorescent member.

10. The light emitting device according to claim 5, wherein the low refractive index layer has a layer thickness of 150 nm or more and 2000 nm or less.

11. The light emitting device according to claim 5, wherein the low refractive index layer is either one of SiO₂ and Al₂O₃.

12. The light emitting device according to claim 1, wherein the fluorescent member comprises a plurality of phosphor particles, and a binder made of an inorganic material.

13. The light emitting device according to claim 1, wherein a surface orthogonal to a traveling direction of laser light is located at a portion of the base body inner surface, and the inclination surface is located lower than said surface orthogonal to the traveling direction of laser light.

14. The light emitting device according to claim 12, wherein a connection member is disposed between the reflecting layer and the base body.

15. The light emitting device according to claim 1, wherein an optical fiber is disposed between the semiconductor laser element and the fluorescent member.

16. The light emitting device according to claim 15, wherein a lens is disposed between the semiconductor laser element and the optical fiber.

17. The light emitting device according to claim 15, wherein the fluorescent member is arranged within the through-hole.

18. The light emitting device according to claim 17, wherein the filter is disposed between the base body inner surface and the fluorescent member 3 at a portion lateral to the fluorescent member.

19. The light emitting device according to claim 15, wherein the filter is a Distributed Bragg Reflector comprising a dielectric multilayer film.

20. The light emitting device according to claim 18, wherein the reflection layer is disposed between the base body inner surface and the filter at the portion lateral to the fluorescent member.
